(19) United States
(12) Patent Application Publication
(10) Pub. No.: US 2009/0114107 A1
(43) Pub. Date: May 7, 2009

(54) PRINTING PRESS WITH A DEVICE OF CONTACTLESS MEASURED DATA ACQUISITION

(75) Inventors: Thomas JOHN, Augsburg (DE); Johann KOENIGER, Kutzenhausen (DE); Ulrich MUELLER, Augsburg (DE); Anton HAMM, Neusaess (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/261,630

(22) Filed: Oct. 30, 2008

(30) Foreign Application Priority Data
Oct. 31, 2007 (DE) 10 2007 052 295.0

(51) Int. Cl. B41F 13/56

(52) U.S. Cl. 101/212; 270/20.1

(57) ABSTRACT

A printing press is disclosed. The printing press includes at least one rotating reel changer, which receives the to-be-printed paper web as a roll, and a printing couple, which applies ink and dampening solution via the rotating cylinder rollers to the paper web, as well as a folding unit with rotating folding unit cylinders for assembling the printed paper web into the desired printed products. A transponder is arranged in at least one rotating component of the printing press and a receiver is arranged in a non-moving part of the printing press.

This application claims the priority of German Patent Document No. 10 2007 052 295.0, filed Oct. 31, 2007, the disclosure of which is expressly incorporated by reference herein.

### BACKGROUND AND SUMMARY OF THE INVENTION

The invention relates to a printing press comprised of at least one rotating reel changer, which receives the to-be-printed paper web as a roll, and a printing couple, which applies ink and dampening solution via the rotating cylinder rollers to the paper web, as well as a folding unit with rotating folding unit cylinders for assembling the printed paper web into the desired printed products.

The correct functioning of a printing press is a function of different parameters. Thus, the machine setting and/or the operating state of a printing press may change in the medium or longer term. In addition, short-term fluctuations may arise in the course of production caused by material parameters, such as, for example, paper (quality), dampening solution, printing ink or blankets.

The bearer ring forces are cited in a non-restrictive manner here as an example of the machine setting. Bearer rings are used on the body ends of the printing couple cylinders, so as, in the case of cylinders that roll off of one another, for example, plate cylinders on transfer cylinders, to deflect the forces arising between the cylinders in the cylinder contact area in the bearing of the cylinders. In this case, the excitations of flexural vibrations caused by the (lock-up) slot impacts are supposed to be improved or reduced by the bearer rings. The bearer ring as such is a consumable part, and bearer ring forces are measured at regular intervals only on a stationary machine in a very involved manner and, as the case may be, readjusted or the bearer ring is replaced.

Operating states that are more likely to be relevant to the printing process, such as the temperature in the printing press or in machine components, are not determined at all. Nevertheless, temperature changes are extremely relevant. Thus, for example, an undesirable heat input to the transfer cylinder or to cylinders adjacent to these may occur because of the drumming work of the blankets on the transfer cylinders. This undesirable heat input is called a hot spot and has a negative impact on the printing process.

Instead, the printing consequences of changes by the operator are compensated for by manual interventions. Errors occur in this case because machine parameters are changed without knowledge of the actual cause.

Until now all characteristics above that are of the most interest, such as the temperature of machine parts rotating during operation, were not recorded, because the data transmission of measured variables via electrical cable and slip rings in the raw operating surroundings of printing presses was not realizable in a satisfactory way.

As a result, the inventors have undertaken the objective of being able to determine measured data from a printing press even during the printing process.

### BRIEF DESCRIPTION OF THE DRAWINGS

FIG. 1 is a schematic illustration of a printing press of the present invention.

FIG. 2 is a schematic illustration of a first embodiment of the present invention.

FIG. 3 is a schematic illustration of a second embodiment of the present invention.

### DETAILED DESCRIPTION OF THE EXEMPLARY EMBODIMENTS

The inventors have recognized that it is possible to measure characteristics that are of interest, such as, for example, the bearer ring forces or the temperature, in a rotating component even during printing operation, if at least one measuring sensor is arranged within this rotating component, which measures specific data, such as the bearer ring force or temperature, and transmits it contactlessly with the aid of a transmitter that is likewise integrated into the rotating component to a receiver in the non-moving part of the printing press, and from there the data are then processed further in the respectively meaningful manner.

From the knowledge attained herefrom, the inventors provide an improved printing press comprised of at least one rotating reel changer, which receives the to-be-printed paper web as a roll, and a printing couple, which applies ink and dampening solution via the rotating cylinder rollers to the paper web, as well as a folding unit with rotating folding unit cylinders for assembling the printed paper web into the desired printed products, to the effect that a transponder is arranged in at least one rotating component of the printing press and a receiver is arranged in a non-moving part of the printing press.

This now makes it possible to measure, for example, bearer ring forces and the temperature in cylinders of the printing press even during the printing operation.

In one possible embodiment, the transponder may be permanently integrated into the component of the printing press. In another possible embodiment, the transponder, which is normally comprised of a transmitter and a sensor, is arranged in the rotating component so that it may be dismantled.

It is advantageous if the transmitter is arranged near the surface shell of the rotating component and the sensor is arranged between the axis of rotation and the surface shell of the rotating component. Because of the close arrangement of the transmitter on the surface shell, it is possible to achieve a favorable transmission efficiency.

The transmitter may be embodied as a radio wave transmitter with a transmitting wavelength between approx. 10⁰ meters to 10⁴ meters. Alternatively or complementarily, the transmitter may be embodied as a microwave transmitter with a transmitting wavelength between approximately 10⁻³ meters to 10⁻¹ meters. Alternatively or complementarily to this, the transmitter may also be embodied as an infrared transmitter with a transmitting wavelength between approx. 10⁻⁶ meters to 10⁻⁴ meters. But transmitters in a UV range between 320 nm [nm=nanometer] to 380 nm or in the visible spectrum between 380 nm and 750 nm are also suitable.

Suitable as sensors are, for example, various bridge circuits, resistance measuring sensors, such as Pt-100 elements, strain gauges or piezoelectric elements. Along with forces, such as radial, axial and circumferential forces in the cylinders of the printing press, temperatures and electrical voltages or electrical charge states may be detected. The pressure and moisture on diverse component surfaces are also able to be determined with the sensors. The invention also may include using at least one microphone as a sensor. A spectrum of an optimally adjusted printing press will be recorded and stored as a function of the frequency. If this noise spectrum should change in the course of the operation of the printing press, then a possible malfunction may be formed on the basis of the change and the frequency. If the sensor is designed as an optical sensor, then it is possible for the sensor to detect contamination in the printing press.

It is advantageous if the transmitter has its own energy storage device or an energy supply device is arranged, which inductively couples energy into the transmitter. Conventional batteries, accumulators, or fuel cells, which are installed in the rotating components along with the sensor, are suitable as energy storage devices for the operation of the transponder. In this case, depending upon the storage capacity and the energy requirements of the transponder, a replacement possibility or charging possibility of the energy storage device may be made possible.

Another solution provides for inductively coupling in the energy. In this case, in a design at a small distance of approx. 0.1 mm to 10 mm, preferably 3 mm to 6 mm, with respect to the rotating component, a corresponding electromagnetic coil may be situated in the same axial position of the transponder, which coil, during every pass of the transponder, transmits energy to a coil integrated into the transponder, which charges a likewise integrated capacitor until its energy is sufficient for a measuring process including transmitting the radio signal.

The external coil for coupling in the energy is preferably housed in a non-moving machine part of the printing press.

The external coil and the radio receiver may be separate structural units or may be combined in one unit.

The measuring signals that are obtained in this manner may then, depending upon their type, continuously detect the machine status. This makes analysis and documentation as well as a direct further processing of the signals with the machine control possible.

In the case of the bearer ring forces mentioned at the outset, when limit values are exceeded, a warning may be given by the machine control, which then for instance enables the operator of the machine to initiate a readjustment in a targeted manner. In this case, the readjustment may be accomplished by suitable actuators, such as, for example, by linear drives, hydraulic or pneumatic cylinders.

In the case of other measured variables, such as temperatures for instance, the measuring signal may be used to directly influence printing process manipulated variables via the machine control. Thus, when a specific cylinder temperature is exceeded, a cooling circuit may be activated.

With this technology, the suitable sensors may be used at one position, or as many as desired positions, of a rotating component to detect measuring signals. In this connection, several sensors may be combined with an energy coupling and radio unit.

In this case, one may be dealing in general with variables, which are present in the rotating component itself, but also with variables, which are produced when the rotating part makes contact with other parts, for instance with corresponding rotating parts or with material webs, such as the to-be-printed or already printed paper for instance.

In order to be able to reliably transmit a radio signal to the receiver in the case of parts that in some cases are rotating quickly and a shielding effect that is probable in printing presses because of large, massive machine parts made of steel, synchronization is necessary, as the case may be, in such a way that the radio signal is then transmitted when the transponder passes directly by the receiver antenna. This may be realized for instance in that, with a combined unit of an external energy coupling and a receiver, the signal is transmitted directly after a renewed energy transmission.

As an alternative to this, the transmission time may be dimensioned in such a way that, even with a low rotational speed, transmission takes place for at least one full rotation.

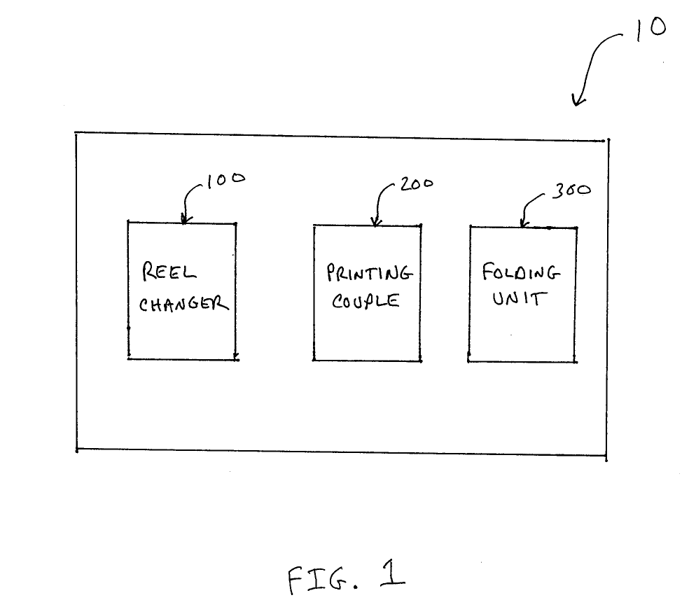

Embodiments of the invention are schematically illustrated in FIGS. 1 to 3. As can be seen in FIG. 1, a printing press 10 includes a rotating reel changer 100, which receives a paper web as a roll, a printing couple 200, which applies ink and dampening solution via rotating cylinder rollers of the printing couple to the paper web, and a folding unit 300 with rotating folding unit cylinders for assembling the paper web after printing.

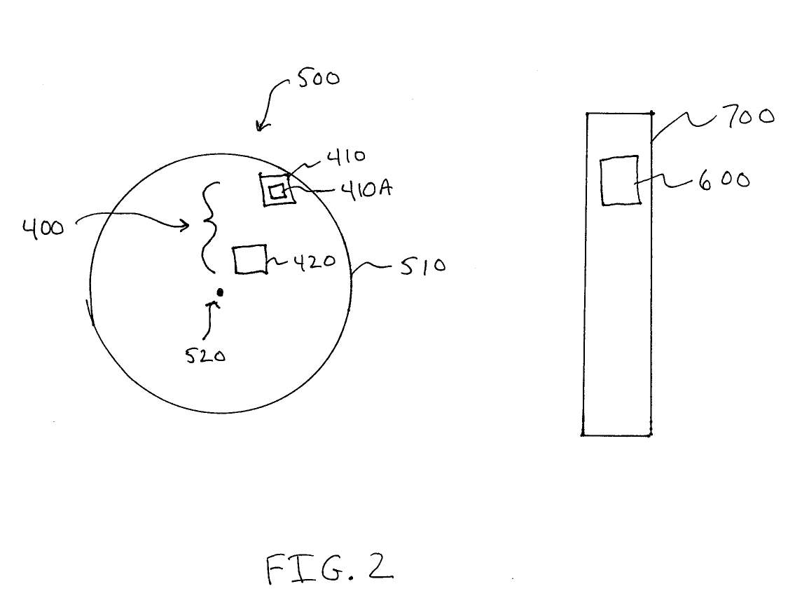

As can be seen in FIG. 2, a transponder 400 is arranged in a rotating component 500 of the printing press 10 and a receiver 600 is arranged in a non-moving part 700 of the printing press 10. The rotating component 500 may be any rotating component of the printing press 10, such as a component of the rotating reel changer 100, the printing couple 200, and/or the folding unit 300, e.g., a cylinder. The present invention is not limited to including the transponder in any particular rotating component of the printing press. Additionally, a transponder may be included in multiple rotating components of the printing press. Further, the present invention is not limited to including the receiver in any particular non-moving part of the printing press. In the illustrated embodiment, the non-moving part 700 is a frame member of the printing press.

As can be further seen in FIG. 2, the transponder 400 is comprised of a transmitter 410 and a sensor 420. The transmitter 410 is arranged near a surface shell 510 of the rotating component 500 and the sensor 420 is arranged between the axis of rotation 520 and the surface shell 510 of the rotating component 500. In the illustrated embodiment of FIG. 2, the transmitter 410 includes its own energy storage device 410A.

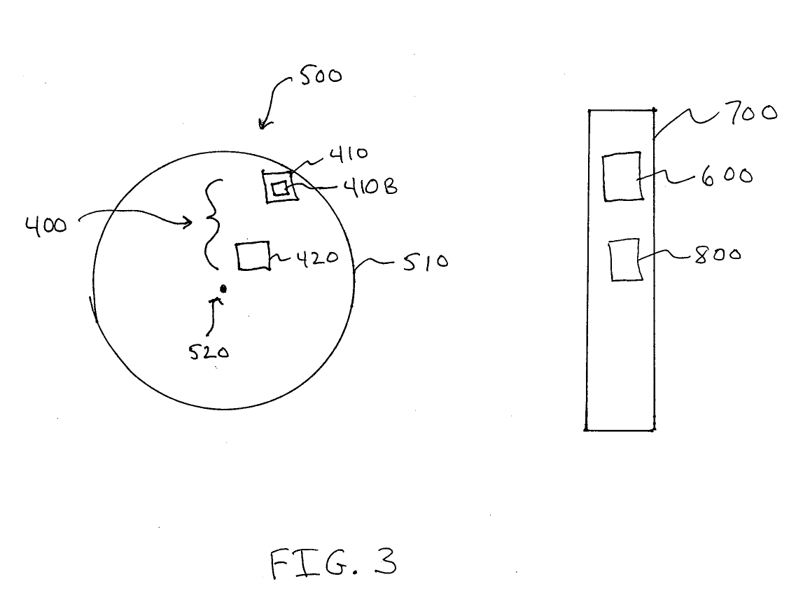

In the alternative embodiment of FIG. 3, an energy supply device 800 inductively couples energy into the transmitter 410. The energy supply device 800 may be a coil, which during every pass of the transponder 400 inductively transmits energy to a coil 410B of the transmitter 410 of the transponder 400. As can be seen, like reference numerals are used in FIGS. 2 and 3 for common components and the common components are not further discussed in connection with FIG. 3. Of particular note, FIGS. 1 to 3 are not drawn to scale, and as discussed above, the energy supply device may be positioned as previously described with respect to the transmitter.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A printing press, comprising a rotating reel changer, which receives a paper web as a roll, a printing couple, which applies ink and dampening solution via rotating cylinder rollers of the printing couple to the paper web, and a folding unit with rotating folding unit cylinders for assembling the paper web after printing, wherein a transponder is arranged in a rotating component of the printing press and a receiver is arranged in a non-moving part of the printing press.

2. The printing press according to claim 1, wherein the transponder is comprised of a transmitter and a sensor and wherein the transponder is arranged in the rotating component so that it is removable from the rotating component.

3. The printing press according to claim 2, wherein the transmitter is arranged near a surface shell of the rotating component and the sensor is arranged between an axis of rotation and the surface shell of the rotating component.

4. The printing press according to claim 2, wherein the transmitter is a radio wave transmitter or a microwave transmitter or an infrared transmitter.

5. The printing press according to claim 2, wherein the transmitter emits electromagnetic radiation in a range of 320 nm to 380 nm or between 380 nm and 750 nm.

6. The printing press according to claim 2, wherein the sensor is a bridge circuit or a strain gauge or a piezoelectric element.

7. The printing press according to claim 2, wherein the transmitter includes an energy storage device.

8. The printing press according to claim 2, wherein an energy supply device inductively couples energy into the transmitter.

9. The printing press according to claim 8, wherein the energy supply device is a coil, which during every pass of the transponder inductively transmits energy to a coil of the transmitter of the transponder.

10. A printing press, comprising:
a rotating component;
a non-moving component;
a transponder arranged in the rotating component; and
a receiver arranged in the non-moving component.

11. The printing press according to claim 10, wherein the transponder includes a transmitter and a sensor.

12. The printing press according to claim 11, wherein the transmitter is arranged near a surface shell of the rotating component and the sensor is arranged between an axis of rotation and the surface shell of the rotating component.

13. The printing press according to claim 11, wherein the transmitter includes an energy storage device.

14. The printing press according to claim 11, further comprising an energy supply device and wherein the energy supply device inductively couples energy into the transmitter.

15. The printing press according to claim 10, wherein the rotating component is a cylinder.
